(19) United States
(12) Patent Application Publication
(10) Pub. No.: US 2014/0229438 A1
(43) Pub. Date: Aug. 14, 2014

(54) MULTIPLE PLATFORM DATA STORAGE AND SYNCHRONIZATION

(71) Applicant: DROPBOX, INC., San Francisco, CA (US)

(72) Inventors: Thomas Carriero, San Francisco, CA (US); Sean Lynch, San Francisco, CA (US)

(73) Assignee: DROPBOX, INC., San Francisco, CA (US)

(21) Appl. No.: 13/765,496

(22) Filed: Feb. 12, 2013

(51) Int. Cl. G06F 17/30

(52) U.S. Cl. CPC G06F 17/30575
USPC 707/625

(57) ABSTRACT

The disclosed technology can enable application data to be stored with an online content management system. In some embodiments, a user's application installed on a first computing device can send application data, such as current state information of the application, to be stored on the network service. If the user's application is also installed on at least a second computing, then the application data (e.g., current state information) stored with the content management system can be transmitted to at least the second computing device, thereby causing the application data for the user's application to be synced with respect to both the first device and the at least the second device. As such, data for the user's application can be synced among multiple, different platforms (e.g., computing devices running different operating systems). Moreover, the disclosed technology can provide approaches to managing conflicts among application data to be synced.

### TECHNICAL FIELD

The present technology pertains to synchronizing data, and more specifically pertains to synchronizing application data, such as current application state information, among multiple platforms.

### BACKGROUND

Computing devices and applications are becoming more commonplace. People use applications on their computing devices every day, especially as mobile applications are growing in number and in function. The various types and models of computing devices are also growing. There are applications that are compatible with a wide variety of computing device platforms. For example, an application can be built to include a version that works on a particular operating system but also have another version(s) that works on another operating system(s). In another example, a gaming application can be installed on a smartphone computing device, on a tablet computing device, as well as on a gaming console system. In other words, in the example, the gaming application can have different versions to work with the different computing devices, which can run different operating systems.

With the increasingly large number of applications and computing devices, it can be difficult for a user to keep track of his data in each of his applications on each of his devices. For example, it can be inconvenient for a user to keep track of his progress in each application on each of his devices. This can reduce the overall user experience associated with using apps on computing devices.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for multiple platform data storage and synchronization. Various embodiments of the present disclosure enable data to be stored with a network service in a networked environment. The data can include, but is not limited to, data used by an application(s) (i.e., application data).

In some embodiments, an application can be installed on multiple platforms. For example, an application can have different versions to be installed for different computing devices running different operating systems. Often times, a user can use and/or own multiple, different platforms. In one example, the user can have a smartphone device that runs operating system A, a tablet device that runs operating system B, and a desktop computing device that runs operating system C. On each of these devices, the user can have installed a particular application (i.e., one compatible version of the particular application for each operating system). Various embodiments of the present disclosure can enable changes, progress, updates, etc., made on one of the user's devices to be reflected onto the other devices of the user as well, even though the devices may correspond to different platforms (e.g., run different operating systems).

In some embodiments, application data for one version of a user's application on a particular platform can be stored at a network service. Application data for another version of the user's application on another platform can also be stored at the network service. When there is a change, update, etc., to the application data on one of the platforms, the change and/or update can be detected and stored at the network service. The network service can then propagate (i.e., transmit back) the change/update to all the platforms having the user's application, thereby syncing the application data for various versions of the user's application on various platforms (e.g., computing devices with different operating systems).

Moreover, in some embodiments, the disclosed technology can detect conflicts among application data to be synced. The disclosed technology can also provide for approaches to handling the detected conflicts. For example, various embodiments of the present disclosure can provide application programming interface (API) calls useful for implementing various conflict resolution algorithms.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows an exemplary configuration of devices and a network in accordance with the invention;

FIG. 2 shows an exemplary system embodiment for multiple platform data storage and synchronization;

FIG. 3 shows an exemplary system embodiment for multiple platform data storage and synchronization;

FIG. 4A shows an exemplary application capable of implementing multiple platform data storage and synchronization;

FIG. 4B shows an exemplary application capable of implementing multiple platform data storage and synchronization;

FIG. 4C shows an exemplary application capable of implementing multiple platform data storage and synchronization;

FIG. 4D shows an exemplary application capable of implementing multiple platform data storage and synchronization;

FIG. 5 shows an exemplary system embodiment for multiple platform data storage and synchronization;

FIG. 6A shows an exemplary application capable of implementing multiple platform data storage and synchronization;

FIG. 6B shows an exemplary application capable of implementing multiple platform data storage and synchronization;

FIG. 6C shows an exemplary application capable of implementing multiple platform data storage and synchronization;

FIG. 6D shows an exemplary application capable of implementing multiple platform data storage and synchronization;

FIG. 7A shows an exemplary application capable of implementing multiple platform data storage and synchronization;

FIG. 7B shows an exemplary application capable of implementing multiple platform data storage and synchronization;

FIG. 8 shows an exemplary method embodiment for multiple platform data storage and synchronization;

FIG. 9 shows an exemplary method embodiment for multiple platform data storage and synchronization;

FIG. 10A shows an exemplary possible system embodiment for application recommendation using stored files; and

FIG. 10B shows an exemplary possible system embodiment for application recommendation using stored files.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for storing and syncing data for applications running on various platforms. The disclosed technology can enable application data to be stored with a network and/or online service in a networked environment (e.g., an online content management system). For example, the present disclose can provide application programming interface (API) calls for applications and/or application developers to enable application data to be stored with the network service. In some embodiments, a user's application installed on a first computing device can send application data, such as current state information of the application, to be stored on the network service. If the user's application is also installed on a second computing device, then the application data (e.g., current state information, changes to the application, updates to the application, etc.) stored with the network service can be transmitted to the second computing device, thereby causing the application data for the user's application to be synced with respect to both the first device and the second device. Various data for the user's application can be shared and/or synced among multiple, different platforms (e.g., computing devices running different operating systems). Moreover, the disclosed technology can provide approaches, such as via API calls, for managing conflicts among application data to be synced.

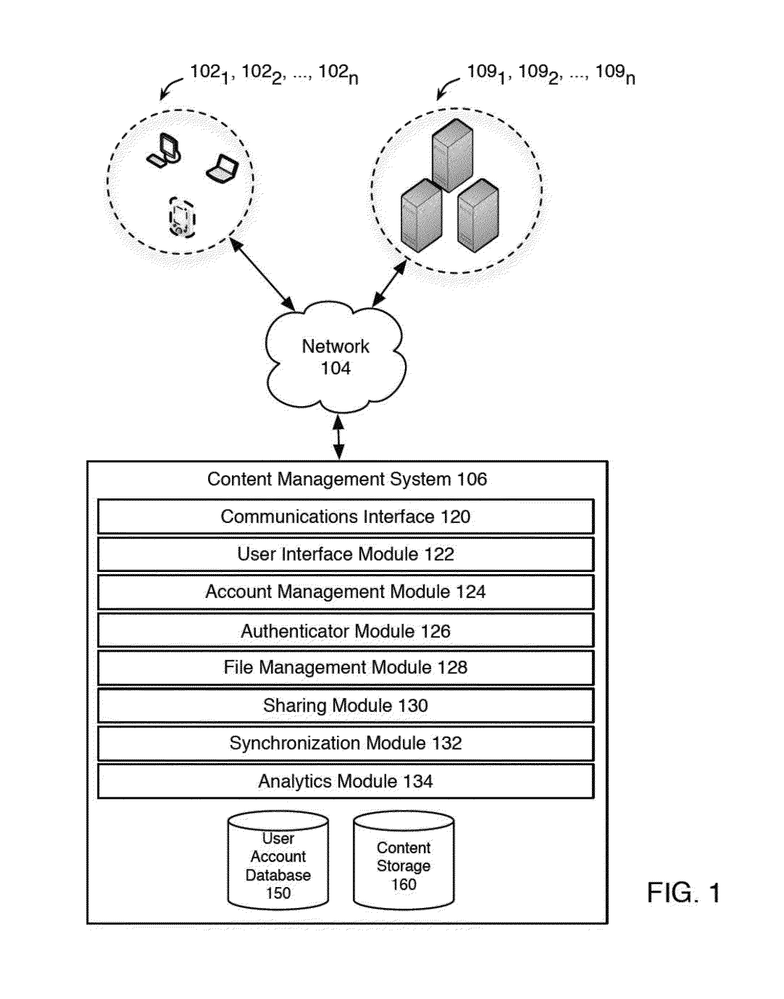

An exemplary system configuration 100 is shown in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, a user can interact with content management system 106 through client devices 102₁, 102₂, . . . , 102ₙ(collectively “102”) connected to network 104 by direct and/or indirect communication. Content management system 106 can support connections from a variety of different client devices, such as desktop computers; mobile computers; mobile communications devices, e.g. mobile phones, smart phones, tablets; smart televisions; set-top boxes; and/or any other network enabled computing devices. Client devices 102 can be of varying type, capabilities, operating systems, etc. Furthermore, content management system 106 can concurrently accept connections from and interact with multiple client devices 102.

A user can interact with content management system 106 via a client-side application installed on client device 102ᵢ. In some embodiments, the client-side application can include a content management system specific component. For example, the component can be a stand-alone application, one or more application plug-ins, and/or a browser extension. However, the user can also interact with content management system 106 via a third-party application, such as a web browser, that resides on client device 102ᵢ and is configured to communicate with content management system 106. In either case, the client-side application can present a user interface (UI) for the user to interact with content management system 106. For example, the user can interact with the content management system 106 via a client-side application integrated with the file system or via a webpage displayed using a web browser application.

Content management system 106 can make it possible for a user to store content, as well as perform a variety of content management tasks, such as retrieve, modify, browse, and/or share the content. Furthermore, content management system 106 can make it possible for a user to access the content from multiple client devices 102. For example, client device 102ᵢ can upload content to content management system 106 via network 104. The content can later be retrieved from content management system 106 using the same client device 102ᵢ or some other client device 102ⱼ.

To facilitate the various content management services, a user can create an account with content management system 106. The account information can be maintained in user account database 150. User account database 150 can store profile information for registered users. In some cases, the only personal information in the user profile can be a username and/or email address. However, content management system 106 can also be configured to accept additional user information.

User account database 150 can also include account management information, such as account type, e.g. free or paid; usage information, e.g. file edit history; maximum storage space authorized; storage space used; content storage locations; security settings; personal configuration settings; content sharing data; etc. Account management module 124 can be configured to update and/or obtain user account details in user account database 150. The account management module 124 can be configured to interact with any number of other modules in content management system 106.

An account can be used to store content, such as documents, text files, audio files, video files, etc., from one or more client devices 102 authorized on the account. The content can also include folders of various types with different behaviors, or other mechanisms of grouping content items together. For example, an account can include a public folder that is accessible to any user. The public folder can be assigned a web-accessible address. A link to the web-accessible address can be used to access the contents of the public folder. In another example, an account can include a photos folder that is intended for photos and that provides specific attributes and actions tailored for photos; an audio folder that provides the ability to play back audio files and perform other audio related actions; or other special purpose folders. An account can also include shared folders or group folders that are linked with and available to multiple user accounts. The permissions for multiple users may be different for a shared folder.

The content can be stored in content storage 160. Content storage 160 can be a storage device, multiple storage devices, or a server. Alternatively, content storage 160 can be a cloud storage provider or network storage accessible via one or more communications networks. Content management system 106 can hide the complexity and details from client devices 102 so that client devices 102 do not need to know exactly where the content items are being stored by content management system 106. In one variation, content management system 106 can store the content items in the same folder hierarchy as they appear on client device 102ᵢ. However, content management system 106 can store the content items in its own order, arrangement, or hierarchy. Content management system 106 can store the content items in a network accessible storage (SAN) device, in a redundant array of inexpensive disks (RAID), etc. Content storage 160 can store content items using one or more partition types, such as FAT, FAT32, NTFS, EXT2, EXT3, EXT4, ReiserFS, BTRFS, and so forth.

Content storage 160 can also store metadata describing content items, content item types, and the relationship of content items to various accounts, folders, or groups. The metadata for a content item can be stored as part of the content item or can be stored separately. In one variation, each content item stored in content storage 160 can be assigned a system-wide unique identifier.

Content storage 160 can decrease the amount of storage space required by identifying duplicate files or duplicate segments of files. Instead of storing multiple copies, content storage 160 can store a single copy and then use a pointer or other mechanism to link the duplicates to the single copy. Similarly, content storage 160 can store files more efficiently, as well as provide the ability to undo operations, by using a file version control that tracks changes to files, different versions of files (including diverging version trees), and a change history. The change history can include a set of changes that, when applied to the original file version, produce the changed file version.

Content management system 106 can be configured to support automatic synchronization of content from one or more client devices 102. The synchronization can be platform agnostic. That is, the content can be synchronized across multiple client devices 102 of varying type, capabilities, operating systems, etc. For example, client device 102ᵢ can include client software, which synchronizes, via a synchronization module 132 at content management system 106, content in client device 102ᵢ's file system with the content in an associated user account. In some cases, the client software can synchronize any changes to content in a designated folder and its sub-folders, such as new, deleted, modified, copied, or moved files or folders. The client software can be a separate software application, can integrate with an existing content management application in the operating system, or some combination thereof. In one example of client software that integrates with an existing content management application, a user can manipulate content directly in a local folder, while a background process monitors the local folder for changes and synchronizes those changes to content management system 106. Conversely, the background process can identify content that has been updated at content management system 106 and synchronize those changes to the local folder. The client software can provide notifications of synchronization operations, and can provide indications of content statuses directly within the content management application. Sometimes client device 102ᵢ may not have a network connection available. In this scenario, the client software can monitor the linked folder for file changes and queue those changes for later synchronization to content management system 106 when a network connection is available. Similarly, a user can manually stop or pause synchronization with content management system 106.

A user can also view or manipulate content via a web interface generated and served by user interface module 122. For example, the user can navigate in a web browser to a web address provided by content management system 106. Changes or updates to content in the content storage 160 made through the web interface, such as uploading a new version of a file, can be propagated back to other client devices 102 associated with the user's account. For example, multiple client devices 102, each with their own client software, can be associated with a single account and files in the account can be synchronized between each of the multiple client devices 102.

Content management system 106 can include a communications interface 120 for interfacing with various client devices 102, and can interact with other content and/or service providers 109₁, 109₂, . . . , 109ₙ (collectively “109”) via an Application Programming Interface (API). Certain software applications can access content storage 160 via an API on behalf of a user. For example, a software package, such as an app on a smartphone or tablet computing device, can programmatically make calls directly to content management system 106, when a user provides credentials, to read, write, create, delete, share, or otherwise manipulate content. Similarly, the API can allow users to access all or part of content storage 160 through a web site.

Content management system 106 can also include authenticator module 126, which can verify user credentials, security tokens, API calls, specific client devices, and so forth, to ensure only authorized clients and users can access files. Further, content management system 106 can include analytics module 134 module that can track and report on aggregate file operations, user actions, network usage, total storage space used, as well as other technology, usage, or business metrics. A privacy and/or security policy can prevent unauthorized access to user data stored with content management system 106.

Content management system 106 can include sharing module 130 for managing sharing content publicly or privately. Sharing content publicly can include making the content item accessible from any computing device in network communication with content management system 106. Sharing content privately can include linking a content item in content storage 160 with two or more user accounts so that each user account has access to the content item. The sharing can be performed in a platform agnostic manner. That is, the content can be shared across multiple client devices 102 of varying type, capabilities, operating systems, etc. The content can also be shared across varying types of user accounts.

In some embodiments, content management system 106 can be configured to maintain a content directory identifying the location of each content item in content storage 160. The content directory can include a unique content entry for each content item stored in the content storage.

A content entry can include a content path that can be used to identify the location of the content item in a content management system. For example, the content path can include the name of the content item and a folder hierarchy associated with the content item. For example, the content path can include a folder or path of folders in which the content item is placed as well as the name of the content item. Content management system 106 can use the content path to present the content items in the appropriate folder hierarchy.

A content entry can also include a content pointer that identifies the location of the content item in content storage 160. For example, the content pointer can include the exact storage address of the content item in memory. In some embodiments, the content pointer can point to multiple locations, each of which contains a portion of the content item.

In addition to a content path and content pointer, a content entry can also include a user account identifier that identifies the user account that has access to the content item. In some embodiments, multiple user account identifiers can be associated with a single content entry indicating that the content item has shared access by the multiple user accounts.

To share a content item privately, sharing module 130 can be configured to add a user account identifier to the content entry associated with the content item, thus granting the added user account access to the content item. Sharing module 130 can also be configured to remove user account identifiers from a content entry to restrict a user account's access to the content item.

To share content publicly, sharing module 130 can be configured to generate a custom network address, such as a uniform resource locator (URL), which allows any web browser to access the content in content management system 106 without any authentication. To accomplish this, sharing module 130 can be configured to include content identification data in the generated URL, which can later be used to properly identify and return the requested content item. For example, sharing module 130 can be configured to include the user account identifier and the content path in the generated URL. Upon selection of the URL, the content identification data included in the URL can be transmitted to content management system 106 which can use the received content identification data to identify the appropriate content entry and return the content item associated with the content entry.

In addition to generating the URL, sharing module 130 can also be configured to record that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing module 130 can be configured to change the value of the flag to 1 or true after generating a URL to the content item.

In some embodiments, sharing module 130 can also be configured to deactivate a generated URL. For example, each content entry can also include a URL active flag indicating whether the content should be returned in response to a request from the generated URL. For example, sharing module 130 can be configured to only return a content item requested by a generated link if the URL active flag is set to 1 or true. Thus, access to a content item for which a URL has been generated can be easily restricted by changing the value of the URL active flag. This allows a user to restrict access to the shared content item without having to move the content item or delete the generated URL. Likewise, sharing module 130 can reactivate the URL by again changing the value of the URL active flag to 1 or true. A user can thus easily restore access to the content item without the need to generate a new URL.

While content management system 106 is presented with specific components, it should be understood by one skilled in the art, that the architectural configuration of system 106 is simply one possible configuration and that other configurations with more or less components are also possible.

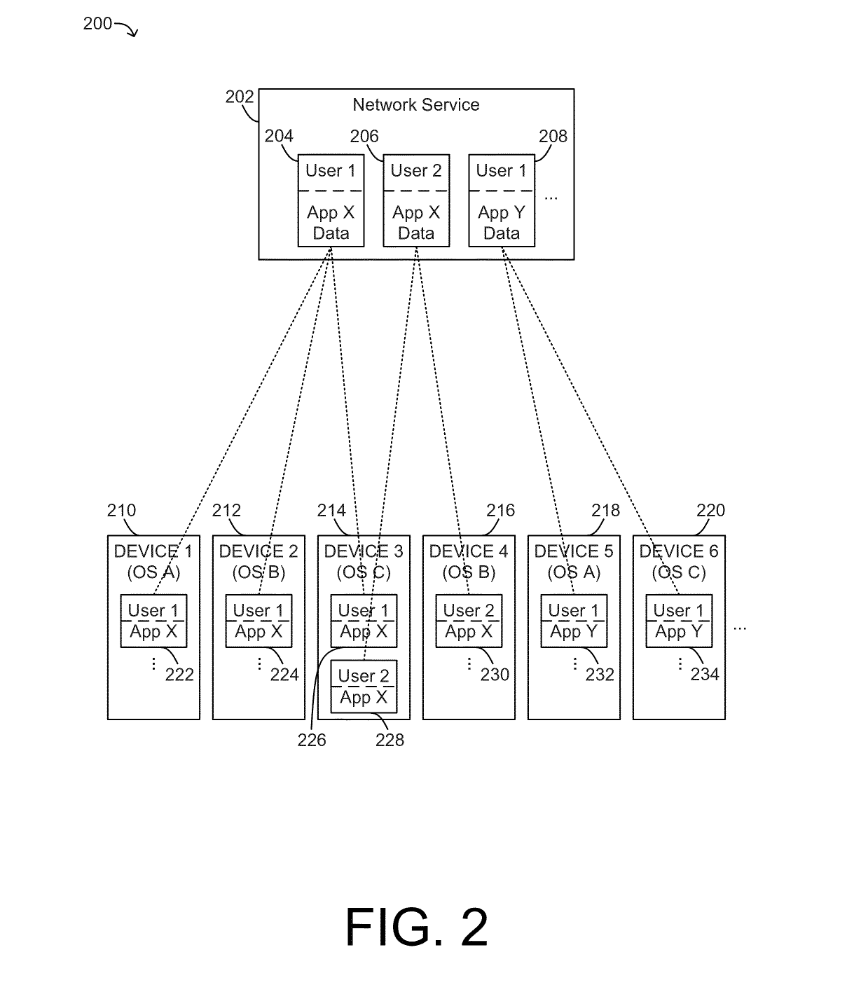

With reference now to FIG. 2, FIG. 2 shows an exemplary system embodiment 200 for multiple platform data storage and synchronization. The exemplary system 200 can include Network Service 202. In some embodiments, Network Service 202 can correspond to content management system 106 of FIG. 1. Network Service 202 (i.e., content delivery system 106) can store various types of data for various purposes, including (but not limited to) application data (i.e., data associated with and/or used by an application(s)). As shown in FIG. 2, Network Service 202 can store, for example, data 204 for App X for User 1, data 206 for App X for User 2, data 208 for App Y for User 1, and so forth. In some embodiments, Network Service 202 can be implemented using one or more servers (e.g., backend server(s)) in a networked environment.

The system 200 can also include a plurality of computing devices, such as Device 1 (210), Device 2 (212), Device 3 (214), Device 4 (216), Device 5 (218), and Device 6 (220), as shown in FIG. 2. The plurality of computing devices, such as Device 1 (210), Device 2 (212), Device 3 (214), Device 4 (216), Device 5 (218), and Device 6 (220), can correspond to client devices 102₁, 102₂, . . . , 102ₙ(collectively “102”) of FIG. 1. The plurality of computing devices can correspond to at least some different platforms. For example, Device 1 (210) can be a smartphone computing device that runs a particular operating system (OS) (e.g., Operating System A), whereas Device 2 (212) can be a smartphone computing device that runs a different operating system (e.g., Operating System B). Moreover, Device 3 (214) can be a tablet computing device that runs Operating System C. Further in contrast, in the example of FIG. 2, tablet Device 4 (216) can run Operating System B, smartphone Device 5 (218) can run Operating System A, and desktop computing Device 6 (220) can run Operating System C, and so on.

FIG. 2 also shows that each of the plurality of computing devices can run one or more applications. Each of the devices, and/or an application on each device, can also be associated with one or more users (e.g., via user accounts). In one example, User 1 can own several devices including the following: smartphone Device 1 (210), smartphone Device 2 (212), tablet Device 3 (214), smartphone Device 5 (218), and desktop Device 6 (220). Moreover, User 2 can own tablet Device 4 (216) and share ownership/usage of tablet Device 3 (214) with User 1.

Continuing with FIG. 2, each device and/or an application on a device can be configured to operate under one or more user accounts. For example, Device 1 (210) can run App X; App X on Device 1 (210) can be associated with user account User 1. Device 2 (212) can also run App X; App X on Device 2 (212) can also be associated with user account User 1. Device 3 (214) can run App X; App X on Device 3 (214) can be run under two different user accounts, User 1 and User 2. Device 4 (216) can run App X; App X on Device 4 (216) can also be associated with user account User 2. Device 5 (218) and Device 6 (220) can each run App Y; each instance/version of App Y on Device 5 (218) and Device 6 (220), respectively, can be associated with user account User 1.

When an app is being executed/run, there can be data corresponding to and/or used by the app (i.e., application data). For example, for a gaming app (i.e., game), there can be state information associated with the user's play. In other words, if the user is at a particular level, has reached a particular state, has achieved a particular score, etc., in the game, then the data about the particular level, state, achievement, etc., for the user can be stored as app data. In another example, a calendar app can include information about a meeting, event, reminder, etc., that the user has set with the calendar app. As such, app data for the calendar app can include information about meetings, events, reminders, etc., for the user. A person with ordinary skill in the art would recognize that there can be various types and kinds of app data that can work in conjunction with the present disclosure.

As shown in FIG. 2, Device 1 (210) can store app data 222 for App X for user account User 1. Device 2 (212) can store app data 224 for App X for user account User 1. Device 3 (214) can store app data 226 for App X for user account User 1. Device 3 (214) can also store app data 228 for App X for user account User 2. Device 4 (216) can store app data 230 for App X for user account User 2. Device 5 (218) can store app data 232 for App X for user account User 1. Device 6 (220) can store app data 234 for App X for user account User 1. The various app data (e.g., 222, 224, 226, 228, 230, 232, 234) can be transmitted to Network Service 202 to enable app data syncing, sharing, etc.

Data 204 for App X for User 1 stored at Network Service 202 can be updated by any one of app data 222, app data 224, or app data 226 from Device 1 (210), Device 2 (212), or Device 3 (214), respectively, even though the three devices can be associated with different platforms (e.g., running different operating systems). In other words, if any one of app data 222, app data 224, or app data 226 has been changed, updated, etc., then the change, update, etc., can be sent to Network Service 202 and be stored at data 204. Then Network Service 202 can propagate the change/update (e.g., data 204) back to app data 222, app data 224, and app data 226, independent of platform. Similarly, data 206 for App X for User 2 can be stored at Network Service 202 and can enable app data sharing/synchronization for app data 228 and app data 230 on Device 3 (214) and Device 4 (216), respectively. Likewise, data 208 for App Y for User 1 stored at Network Service 202 can enable app data sharing/synchronization for app data 232 and app data 234 on Device 5 (218) and Device 6 (220), respectively.

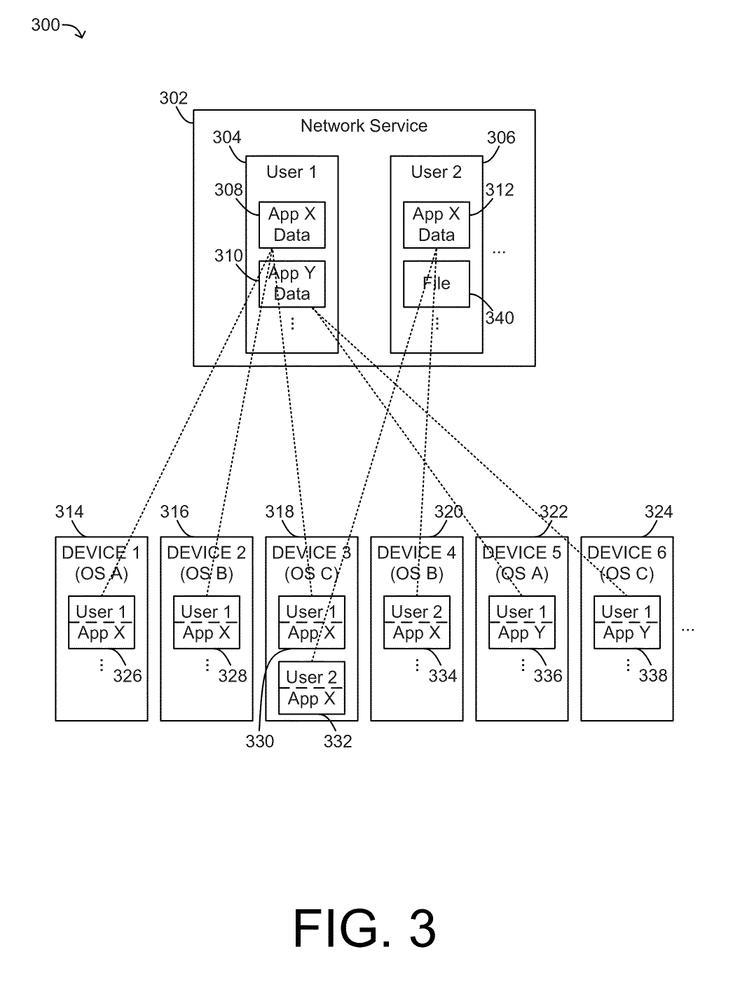

With reference now to FIG. 3, an exemplary system embodiment 300 for multiple platform data storage and synchronization is shown. In some embodiments, Network Service 302 (i.e., content management system 106) can store data for individual users (i.e., user accounts), such as user account User 1 (304) and user account User 2 (306). For example, User 1 can refer to a user who already uses Network Service 302 (i.e., User 1 already has an account with Network Service 302). Various embodiments of the present disclosure can enable User 1 to link his Network Service account 304 to one or more apps that can work with Network Service 302 (e.g., App X and App Y). Thus, app data 308 for App X (for User 1) and app data 310 for App Y (for User 1) can be stored at Network Service 302 under User 1's account 304. Therefore, app data 308 can handle (e.g., keep track of, process, etc.) changes/updates from app data 326, app data 328, and app data 330 from Device 1 (314), Device 2 (316), and Device 3 (318), respectively. A change, update, etc., from any one of app data 326, app data 328, and app data 330 can be transmitted to Network Service 302 (and stored at app data 308), and then reflected back to those of app data 326, app data 328, or app data 330 that have not been changed, updated, etc.

Similarly, app data 310 can handle changes, updates, etc., for App Y for User 1. App data 310 can enable app data sharing/syncing for app data 336 and app data 338 on Device 5 (322) and Device 6 (324), respectively. Likewise, app data 312 can handle/process changes, updates, etc., for App X for User 2 and thereby enable app data sharing/syncing for app data 332 and app data 334 on Device 3 (318) and Device 4 (320), respectively.

Furthermore, in some embodiments, files and/or other data stored with a user account at Network Service 302 can be accessed by an authorized application. For example, file 340 on Network Service 302 can be a file, such as a picture or document of User 2. If User 2 so authorizes, App X (e.g., on Device 3 (318) and/or Device 4 (320)) can access file 340, such as to enhance, modify, and/or otherwise utilize file 340. (Similar to discussions above, Device 1 (314), Device 2 (316), Device 3 (318), Device 4 (320), Device 5 (322), and Device 6 (324), etc., can correspond to client devices 102₁, 102₂, . . . , 102ₙ of FIG. 1.)

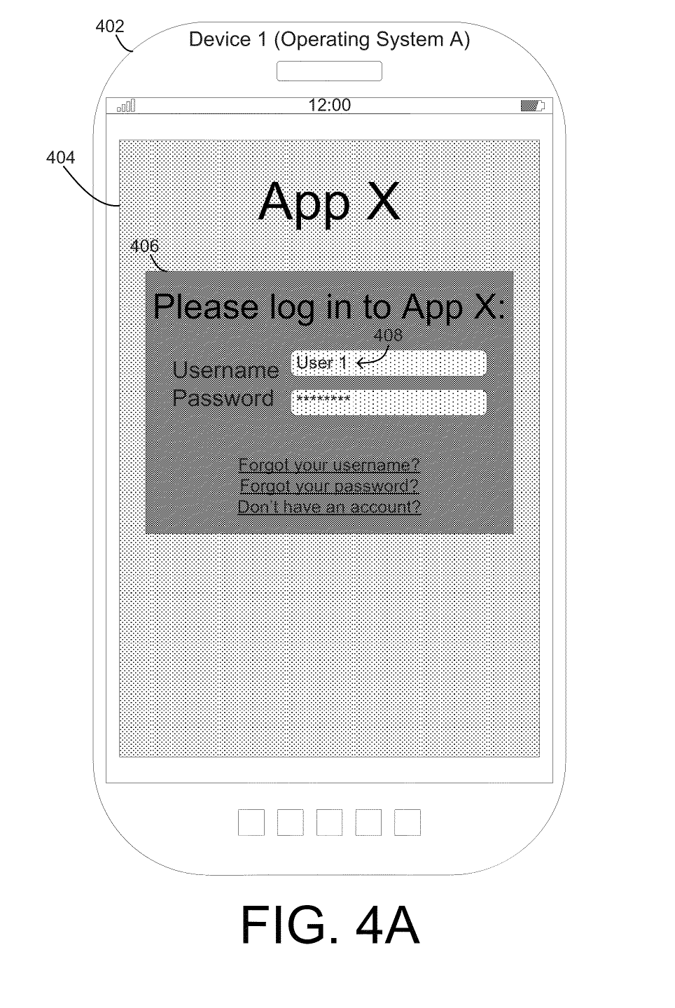

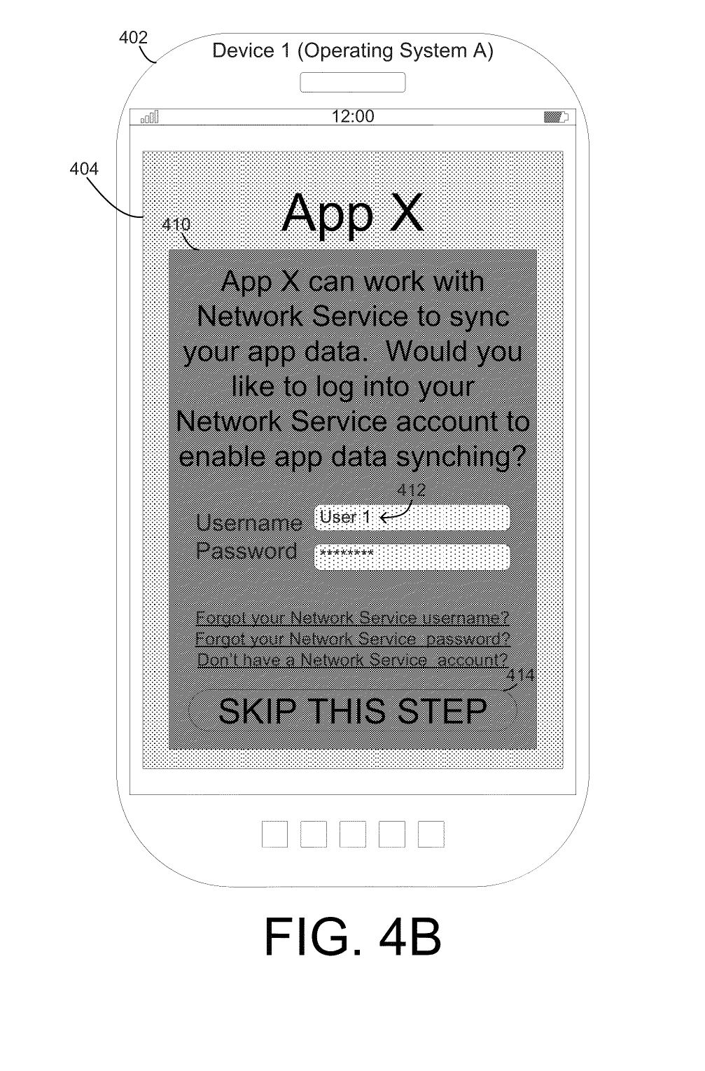

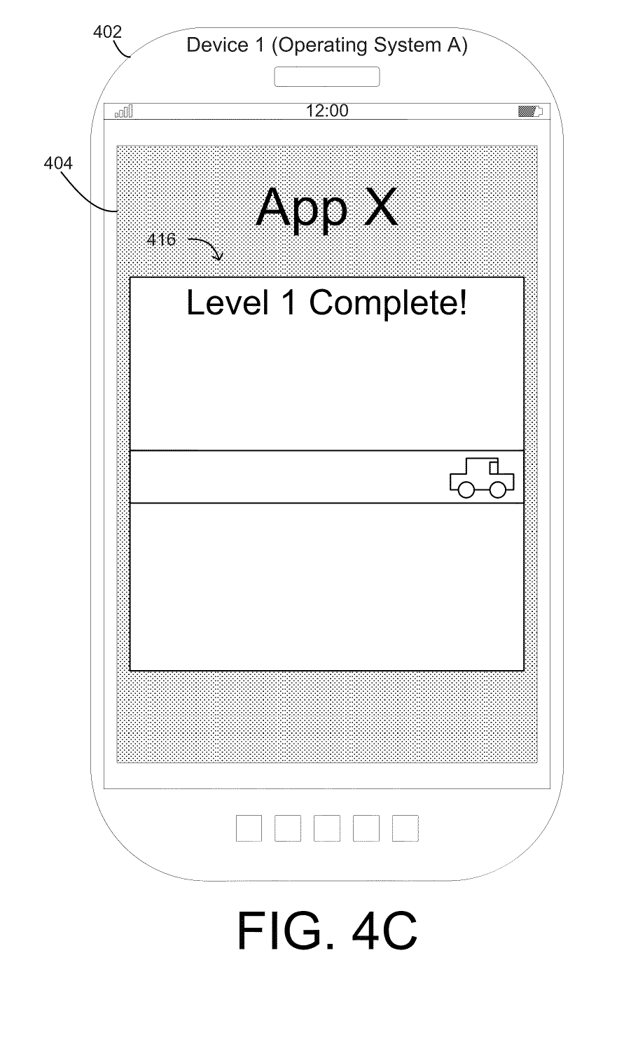

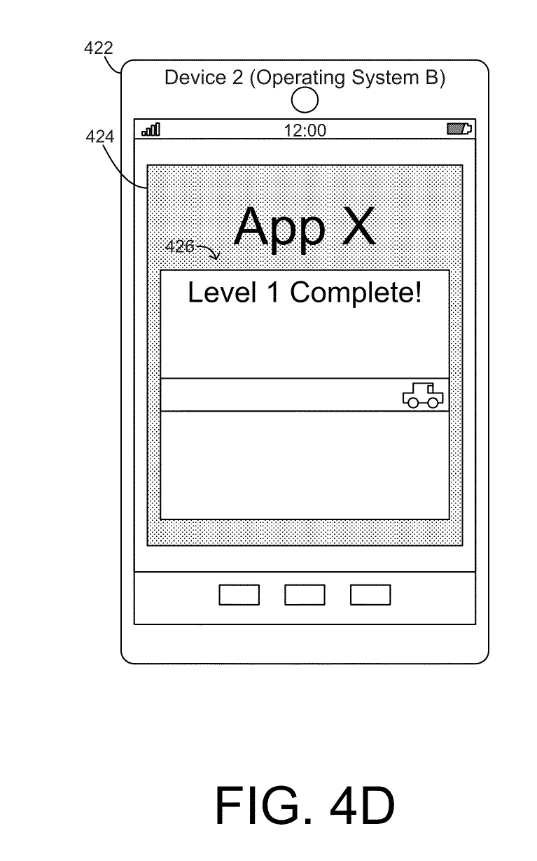

FIG. 4A shows an exemplary computing device embodiment running an exemplary application capable of utilizing multiple platform data storage and synchronization. The exemplary computing device 402 (i.e., Device 1 (314)) of FIG. 4A can run an application 404 (e.g., a version 404 of App X that is compatible with Operating System A of Device 1). In some embodiments, App X 404 can optionally present a prompt 406 to the user (e.g., User 1) to request the user to log into App X 404 with his username and password. The user can enter his username and log into his App X account (e.g., User 1 (408)). This allows App X 404 to be used by multiple users, such that each user can have his own account and his own app data for App X 404. In some embodiments, App X 404 need not prompt 406 the user to log in, such as when App X 404 does not need individualized data for different users on a single computing device or when the user has already been logged in through another mechanism.

FIG. 4B shows an exemplary computing device embodiment running an exemplary application capable of utilizing multiple platform data storage and synchronization. In FIG. 4B, the exemplary computing device 402 (i.e., Device 1 (314)) running App X 404 can prompt 410 the user for authorization to enable app data sharing/syncing using Network Service (e.g., 302). If the user already has a user account with Network Service, then the user can log into his Network Service account. FIG. 4B shows, for example, that the user has an account with Network Service (e.g., User 1 (304, 412)). If the user wants to enable app data sharing/syncing via Network Service but does not have a Network Service account, the user can select the link “Don't have a Network Service account?” in order to register an account with Network Service. Optionally, the user can also choose not to enable app data syncing by selecting button 414 to “SKIP THIS STEP”.

FIG. 4C shows an exemplary computing device embodiment running an exemplary application capable of utilizing multiple platform data storage and synchronization. In one example, the computing device 402 (i.e., Device 1 (314)) of FIG. 4C can run a gaming app, App X 404. As shown in FIG. 4C, the user has completed Level 1 of App X 404. Assuming that the user has logged into his Network Service account (e.g., User 1 (412)) and enabled app data syncing, then information about the current state 416 of App X 404 for User 1 (412) can be stored as app data 326 for App X for User 1 on Device 1 (e.g., 314, 402). In other words, app data 326 can be changed/updated to include information indicating that User 1 (412) has completed Level 1 (416) for App X 404 on Device 1 (314, 402).

Continuing with the example, in some embodiments, app data 326 can be generated periodically and then transmitted to Network Service. In some embodiments, app data 326 can be generated and transmitted to Network Service at a specified time(s). In some embodiments, app data 326 can be generated and transmitted to Network Service when the user pauses and/or exits App X 404. In some embodiments, app data 326 can be generated and transmitted to Network Service when a change, update, etc., occurs. When Network Service 302 receives app data 326 (including App X state information 416), it can change/update data 308 for App X for User 1 (304, 412). Accordingly, the changed/updated data 308 (including App X state information 416) can be transmitted back to Device 2 (316) to change/update app data 328 and also to Device 3 (318) to change/update app data 330. As such, any change/update to app data on one device can enable the change/update to be reflected among app data for other linked/synced devices, no matter what platforms the devices are associated with.

FIG. 4D shows an exemplary computing device embodiment running an exemplary application capable of utilizing multiple platform data storage and synchronization. In FIG. 4D, the exemplary computing device 422 can be another device of User 1 (412), different from computing device 402 (Device 1 (314)). For example, the exemplary computing device 422 of FIG. 2 can be Device 2 (316). Whereas Device 1 (314, 402) can run Operating System A, Device 2 (316, 422) of FIG. 4D can run Operating System B. Device 2 (316, 422) with Operating System B can also run App X 424 (i.e., version 424 of App X that is compatible with Operating System B). Assuming that the user has enabled app data syncing and has logged into his Network Service account for App X 424 on Device 2 (316, 422), then the change/update from app data 326 on Device 1 (314, 402) in the previous example can propagate from Network Service 302 to app data 328 on Device 2 (316, 422). Accordingly, when User 1 (412) opens up App X 424 on Device 2 (316, 422), the state 426 of App X 424 on Device 2 (316, 422) can be the same as the state 416 of App X 404 on Device 1 (314, 402). As such, if User 1 had just completed Level 1 in App X on Device 1 and then exits App X on Device 1, when User 1 subsequently opens App X on Device 2, App X on Device 2 can also show that User 1 had just completed Level 1. (Similar to discussions above, Device 1 (402) and Device 2 (422), etc., can correspond to client devices 102₁, 102₂, . . . , 102ₙ of FIG. 1.)

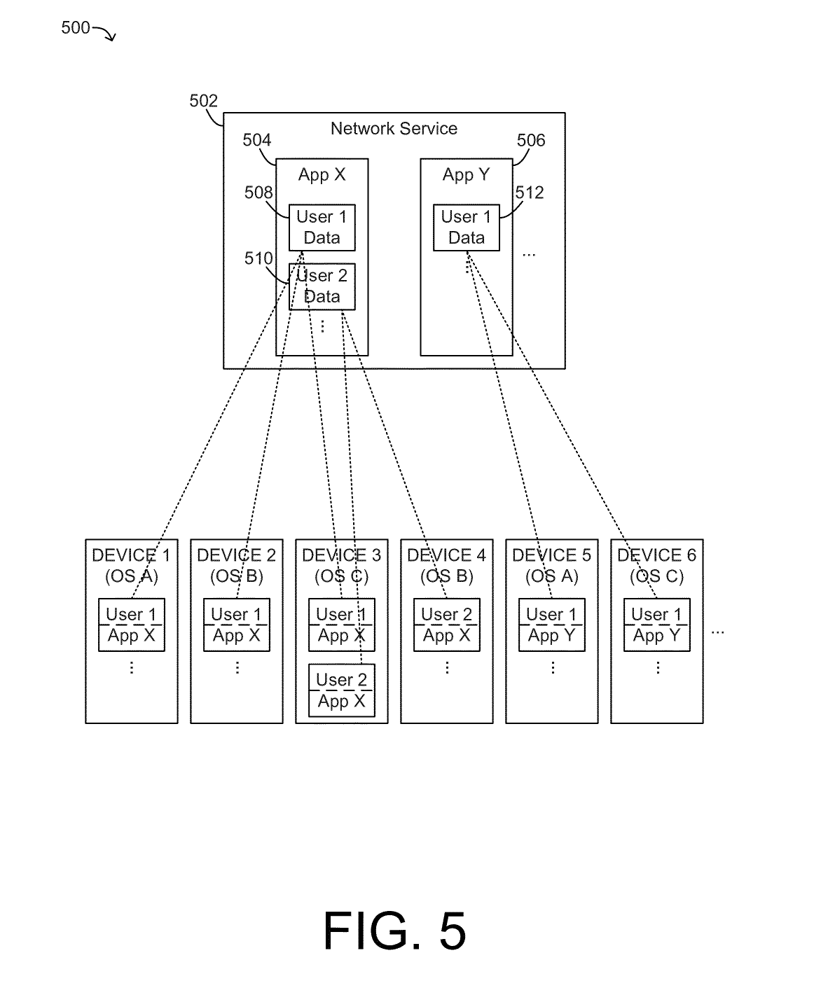

FIG. 5 shows an exemplary system embodiment 500 for multiple platform data storage and synchronization. In some embodiments, Network Service 502 (i.e., content management system 106) can store app data for each individual application, as shown in FIG. 5. In other words, each application (e.g., App X, App Y, etc.) can have its own account with Network Service 502. As such, in some embodiments, an application can be designed to implement multiple platform app data syncing, without requiring the user to have his own Network Service 502 account. For example, App X can have account 504 and App Y can have account 506 with Network Service 502. Within each application account, there can be app data for a particular user(s). As shown in FIG. 5, account 504 for App X can store App X data 508 for User 1 and App X data 510 for User 2, whereas account 506 for App Y can store App Y data 512 for User 1.

Continuing with the example, App X data 508 for User 1 can enable (e.g., handle, manage, process, etc.) data syncing for User 1's App X data on Device 1, Device 2, and Device 3, even though the three devices are on different platforms. App X data 510 for User 2 can enable data syncing for User 2's App X data on Device 3 and Device 4, independent of platform. Moreover, App Y data 512 for User 1 can enable data syncing for User 1's App Y data on Device 5 and Device 6, no matter what platform Like mentioned above, Device 1, Device 2, Device 3, Device 4, Device 5, and Device 6, etc., can correspond to client devices 102₁, 102₂, . . . , 102ₙ(collectively “102”) of FIG. 1.

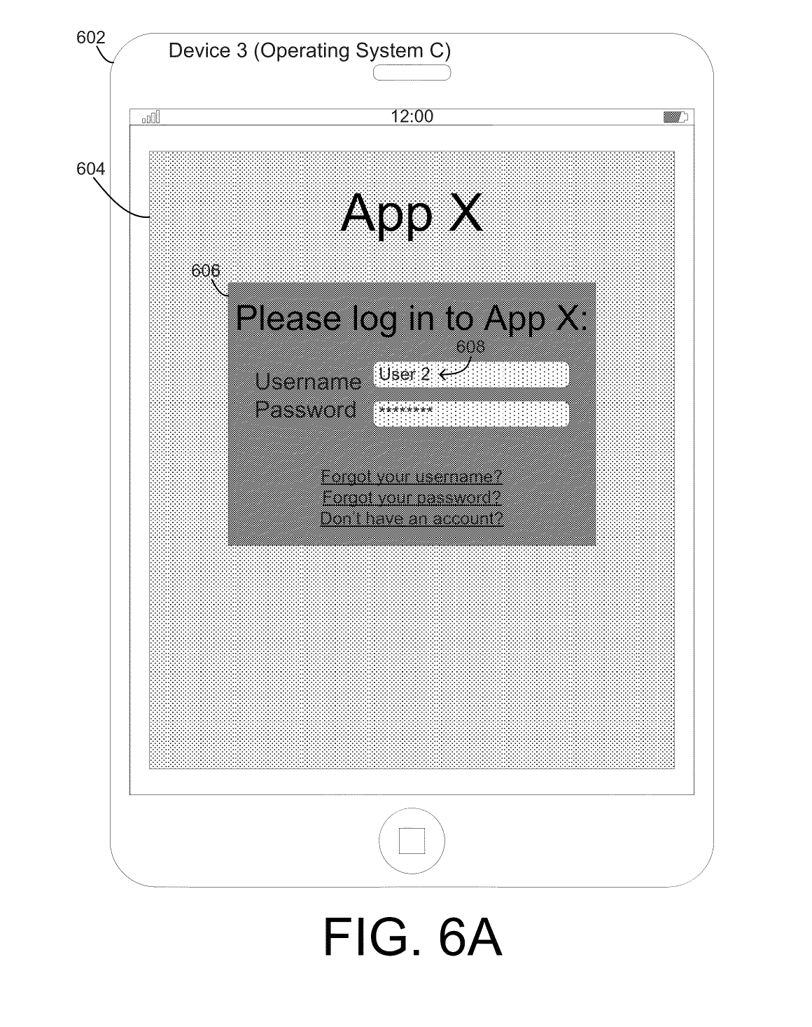

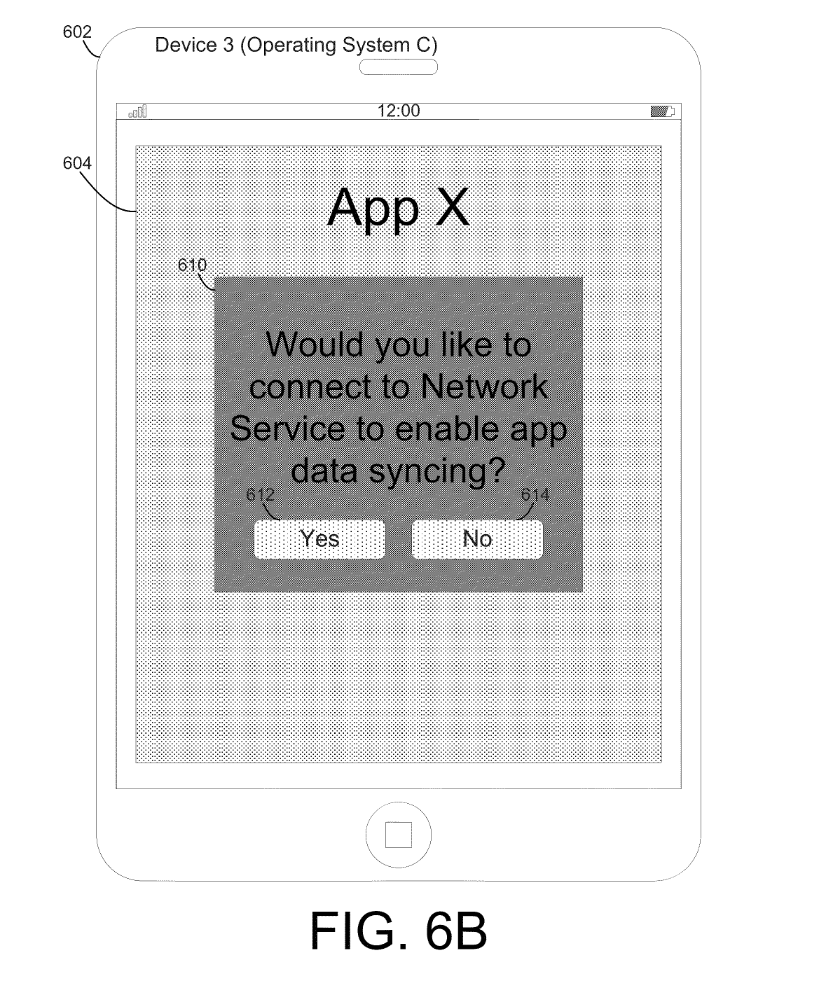

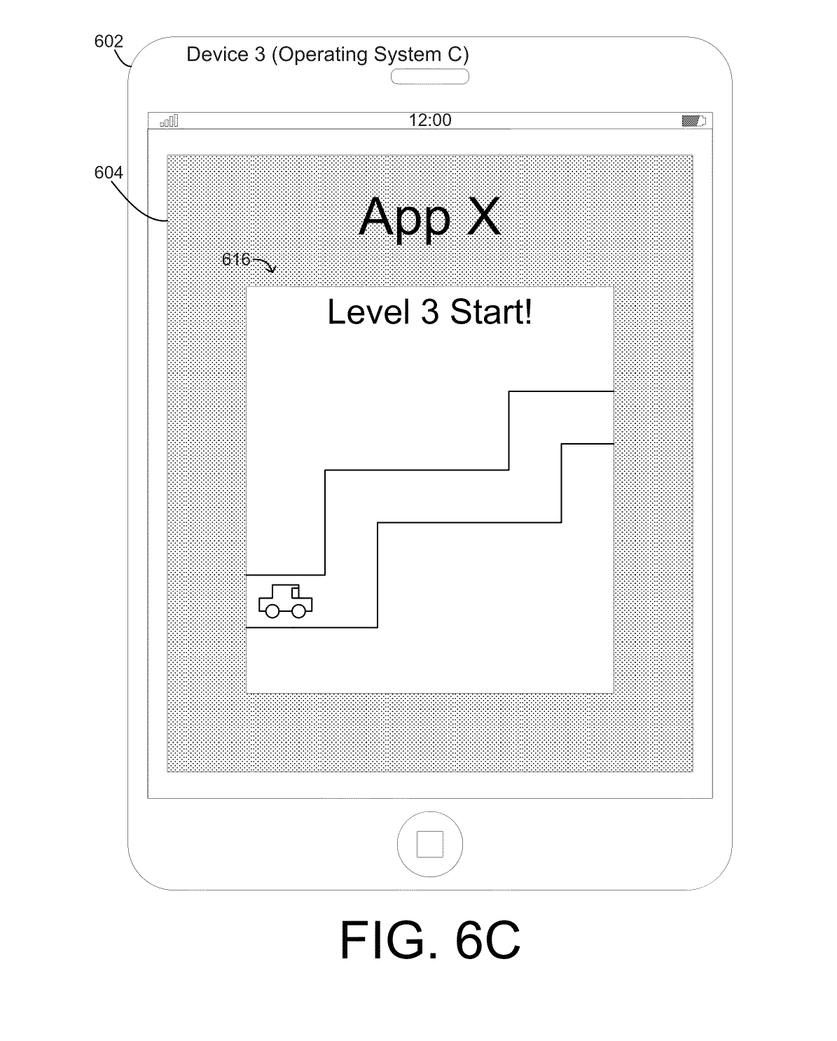

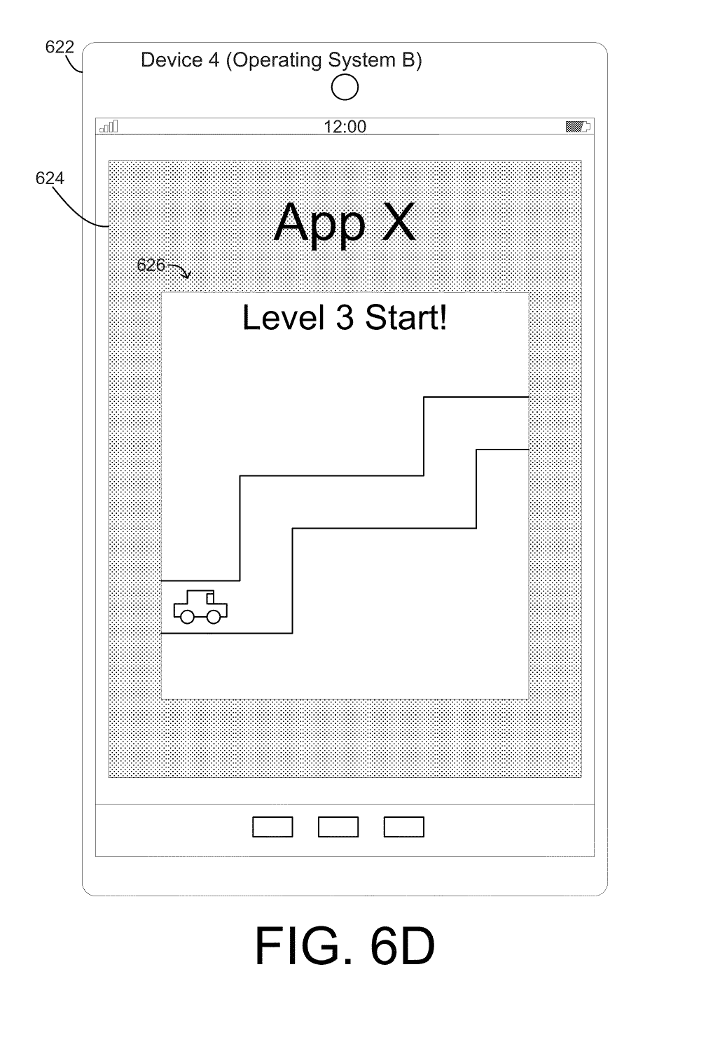

FIG. 6A shows an exemplary computing device embodiment running an exemplary application capable of utilizing multiple platform data storage and synchronization. In FIG. 6A, exemplary computing device 602 (e.g., Device 3 running Operating System C) can execute App X 604 (i.e., version 604 of App X that is compatible with Operating System C). In some embodiments, an application (e.g., App X 604) can be developed, configured, modified, etc., to work in conjunction with its own account (e.g., 504) with Network Service 502. As discussed previously, the application can be designed to implement multiple platform app data syncing by default, without requiring the user to have his own Network Service account. FIG. 6A shows App X 604 prompting 606 the user to log into App X 604. For example, the user can input his App X user account (e.g., User 2 (608)) in order to log into App X 604.

Once the user is logged in, App X 604 can optionally prompt 610 the user to request authorization to enable app data syncing, as shown in FIG. 6B. The user can choose to allow 612 or disallow 614 app data syncing. However, in some embodiments, App X 604 can enable app data syncing by default, without requiring authorization from the user.

Assuming that app data syncing has been enabled, state information and/or other app data for App X for User 2 (e.g., 608) can be synced among multiple devices of User 2 running App X. Again, the syncing among multiple devices can be independent of device platforms. FIG. 6C shows an exemplary computing device embodiment running an exemplary application capable of utilizing multiple platform data storage and synchronization. In one example, User 2 is just about to start Level 3 of App X 604 on Device 3 (602), as shown in FIG. 6C. However, User 2 decides to pause and/or exit out of App X 604 on Device 3 (602). In some embodiments, when User 2 pauses and/or exits App X 604 on Device 3 (602), app data for App X 604 can be sent from Device 3 (602) to App X's Network Service account (e.g., account 504). The app data can indicate the state 616 of App X 604 for User 2 on Device 3 (620) and can be stored as app data 510 for User 2. Network Service 502 can propagate (i.e., transmit, reflect, etc.) app data 510 back to other linked applications on other devices no matter their platforms (e.g., App X for User 2 on Device 4 running Operating System B).

As shown in FIG. 6D, when User 2 subsequently opens/launches App X 624 (i.e., version 624 of App X that is compatible with Operating System B) on Device 4 (622), the state 626 of App X 624 can be the same as the state 606 (e.g., start of Level 3) of App X 604 on Device 3 (602) when the user previously paused/exited. As such, User 2 can resume using App X 624 on Device 4 (622) without losing any progress made from previously using App X 604 on Device 3 (602). If User 2 stops using App X 624 on Device 4 (622) and switches back to using App X 604 on Device 3 (602), then any progress made from using App X 624 on Device 4 (622) can also be updated with respect to App X 604 on Device 3 (602). (Like mentioned above, Device 3 (602) and Device 4 (622), etc., can correspond to client devices 102₁, 102₂, . . . , 102ₙ(collectively “102”) of FIG. 1.)

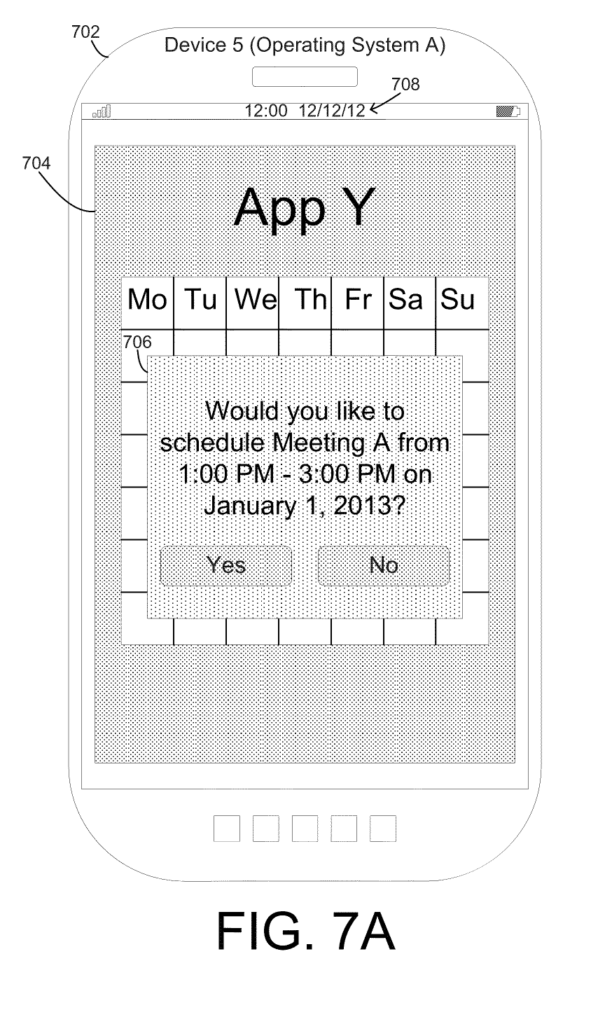

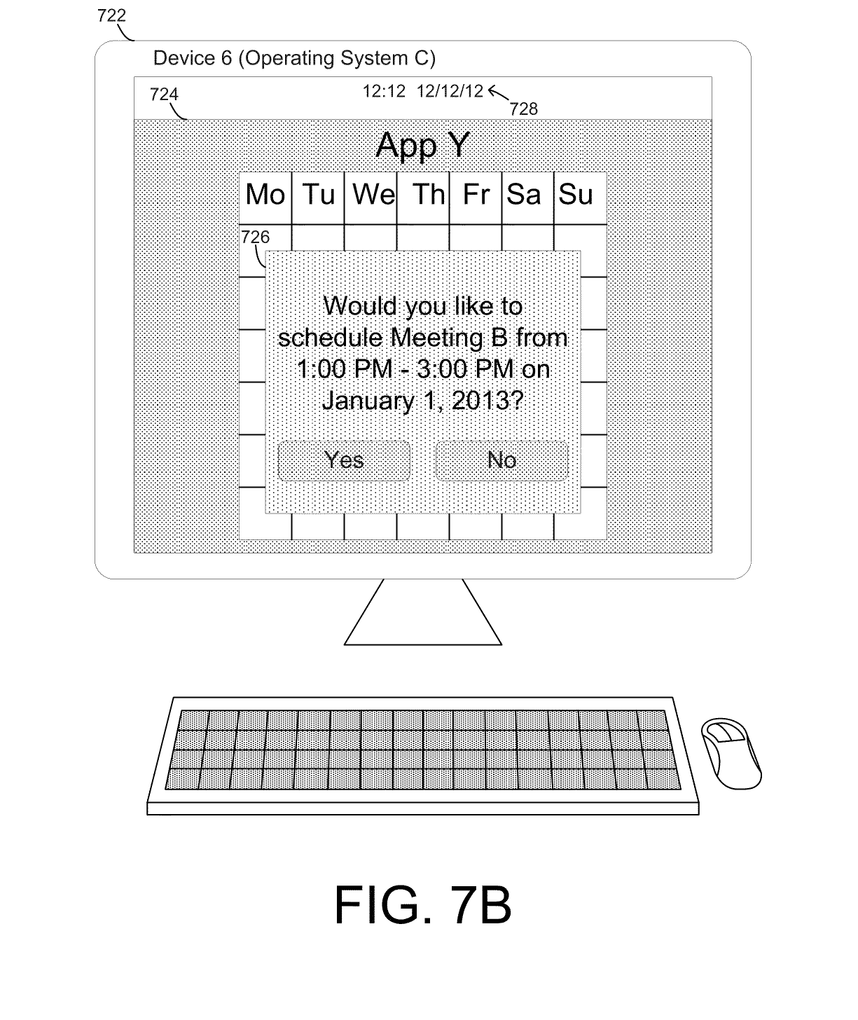

Various embodiments of the present disclosure can also enable sync conflict management. A sync conflict can be an event that occurs when pieces of overlapping, but differing, data would overwrite one another. With reference to FIG. 7A, there can be an exemplary computing device embodiment 702 running an exemplary application capable of utilizing multiple platform data storage and synchronization. The exemplary application 704 running on the computing device embodiment 702 (i.e., client device 102 in FIG. 1) can be, for example, a calendar app: App Y 704 (i.e., version 704 of App Y that is compatible with Device 5's Operating System A). An example of a sync conflict can involve a user attempting to schedule two different meeting events at the same time or within an overlapping time period.

In FIG. 7A, the user can schedule 706 Meeting A from 2:00 to 4:00 PM on Jan. 1, 2013, for example. The scheduled Meeting A event can be included in the app data for the calendar App Y 704. The Meeting A event included in the app data for App Y 704 can be sent and stored at Network Service. Assuming app data syncing has been enabled, another device(s) of the user having App Y (i.e., another version of App Y) can receive the scheduled Meeting A event from Network Service.

FIG. 7B shows an exemplary computing device embodiment 722 (i.e., client device 102 in FIG. 1) running an exemplary application capable of utilizing multiple platform data storage and synchronization. Continuing with the previous example, calendar App Y 724 (i.e., version 724 of App Y that is compatible with Device 6's Operating System C) can receive the scheduled Meeting A event. If the user attempts to schedule Meeting B from 1:00 to 3:00 PM on Jan. 1, 2013, a sync conflict event can occur. In some embodiments, the present disclosure can provide approaches to managing (e.g., resolving, merging, etc.) conflicts. For example, the present disclosure can provide API calls to applications (and/or application developers) for managing sync conflicts.

In some embodiments, a conflict resolution algorithm can be utilized to resolve sync conflicts. In some embodiments, a most-recently-used algorithm can be utilized. As such, API calls can enable the most recent app data to override other data when there is a sync conflict(s). With reference to the previous example, applying the most-recently-used conflict resolution algorithm, Meeting B 726 can override Meeting A 706 because Meeting B was scheduled at a more recent time 728 (e.g., 12:12 on Dec. 12, 2012) than the time 708 at which Meeting A was scheduled (e.g., 12:00 on Dec. 12, 2012).

In another example, a conflict event can occur when multiple contact information entries are entered in an address book app, but the contact information entries contain conflicting contact information. In a further example, a conflict event can occur for a plurality of conflicting document versions. In some cases, the most-recently-used algorithm can resolve conflicting contact information entries and conflicting document versions.

In some embodiments, the conflict resolution algorithm can attempt to resolve conflicts by merging data. In one example, a conflict event can occur for a plurality of conflicting files names. The data merging algorithm can keep the plurality of files with conflicting file names by modifying the file names, thereby preventing the need to overwrite, delete, or substantively modify any files. In another example, a conflict event can occur for contact entries with conflicting contact data. The data merging algorithm can merge the two pieces of conflicting contact data. If, for example, two contact entries have the same name, but one includes only a phone number and the other includes only an email address, the two entries can be merged into one contact entry with the same name and both the phone number and the email address. Similarly, for example, if two contact entries have the same name but two conflicting phone numbers, both phone numbers can be included in a single merged contact entry of the same name. It is contemplated that a person having ordinary skill in the art would recognize various other conflict events.

In some embodiments, the conflict resolution algorithm can involve choosing a state that is associated with a higher prioritized computing device. For example, a user's primary computing device (e.g., smartphone) can have a higher priority than the user's secondary computing device (e.g., tablet). Applying this approach, a meeting event scheduled using the primary device can override an event scheduled using the secondary device. In addition, a person having ordinary skill in the art would recognize various other ways, approaches, and/or implementations for conflict resolution algorithms.

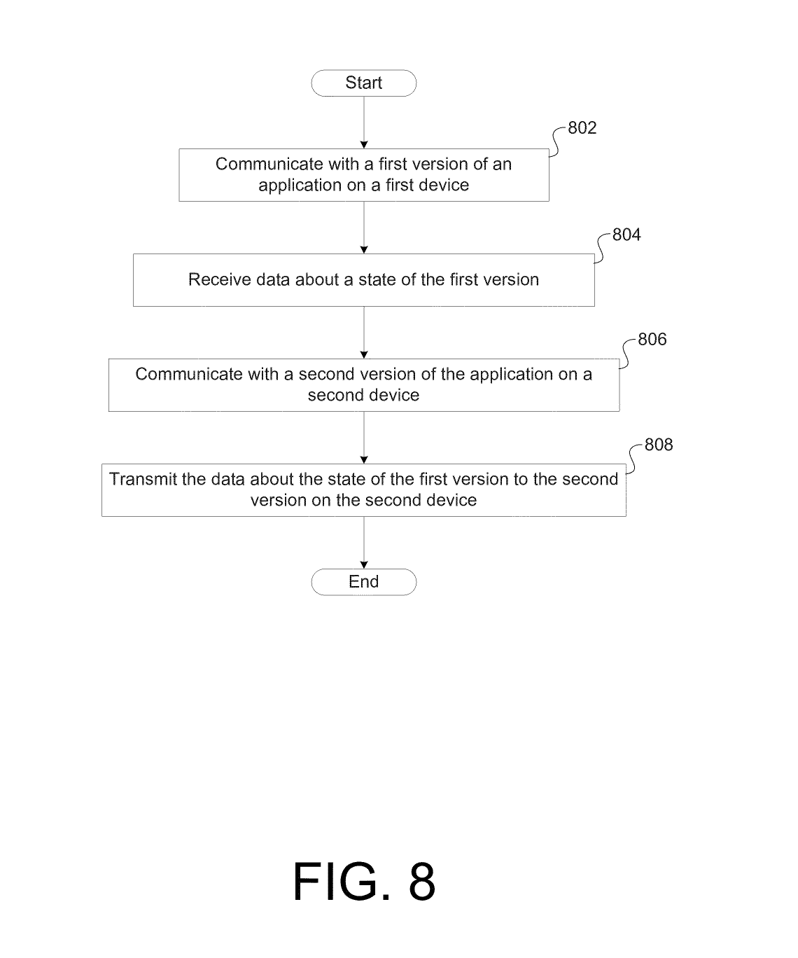

FIG. 8 shows an exemplary method embodiment 800 for multiple platform data storage and synchronization. It should be understood that there can be additional, fewer, or alternative steps performed in similar or alternative orders, or in parallel, within the scope of the various embodiments unless otherwise stated. The method embodiment 800 can begin with communicating with a first version of an application on a first device, at step 802. The first version of the application can be associated with a user account. At step 804, the method 800 can receive data about a state of the first version. The first version of the application can be associated with the user account. The receiving can be from the first version of the application on the first device.

At step 806, the method 800 can communicate with a second version of the application on a second device. The second version of the application can also be associated with the user account. Step 808 can include transmitting the data about the state of the first version to the second version on the second device. In some embodiments, the data about the state of the first version can be utilized, at least in part, to configure the second version to have a state synced with the first version. Also, the first device and the second device can correspond to different platforms. For example, the first and second devices can be running different operating systems.

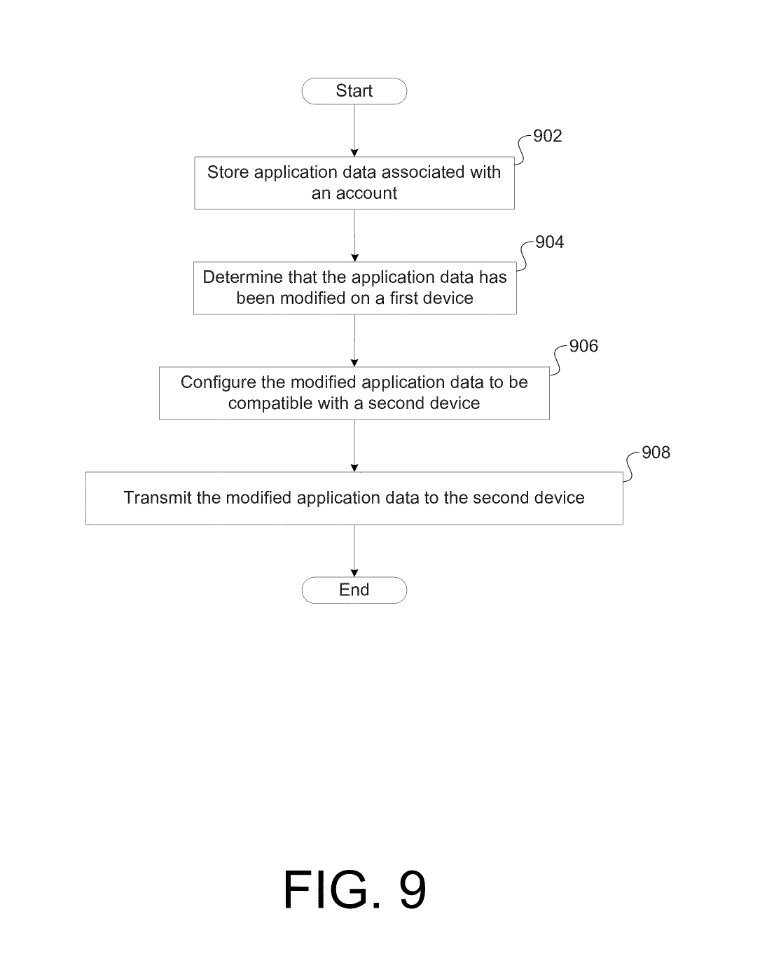

FIG. 9 shows an exemplary method embodiment 900 for multiple platform data storage and synchronization. Again, it should be understood that there can be additional, fewer, or alternative steps performed in similar or alternative orders, or in parallel, within the scope of the various embodiments unless otherwise stated. At step 902, the exemplary method embodiment 900 can store application data associated with an account. In some embodiments, the account can be at least one of a user account associated with an online content management system or an application account associated with the online content management system. At step 904, the method 900 can determine that the application data has been modified on a first device. The first device can also be associated with the account. In some embodiments, the determining that the application data has been modified on the first computing device can comprise receiving a notification indicating that the application data has been modified on the first computing device. In some embodiments, the notification can be associated with at least one of a push notification, a fetch notification, or a periodic poll. Step 906 can include configuring the modified application data to be compatible with a second device. The second device can also be associated with the account and can correspond to a platform different from the first device. Then, at step 908, the method 900 can transmit the modified application data to the second device.

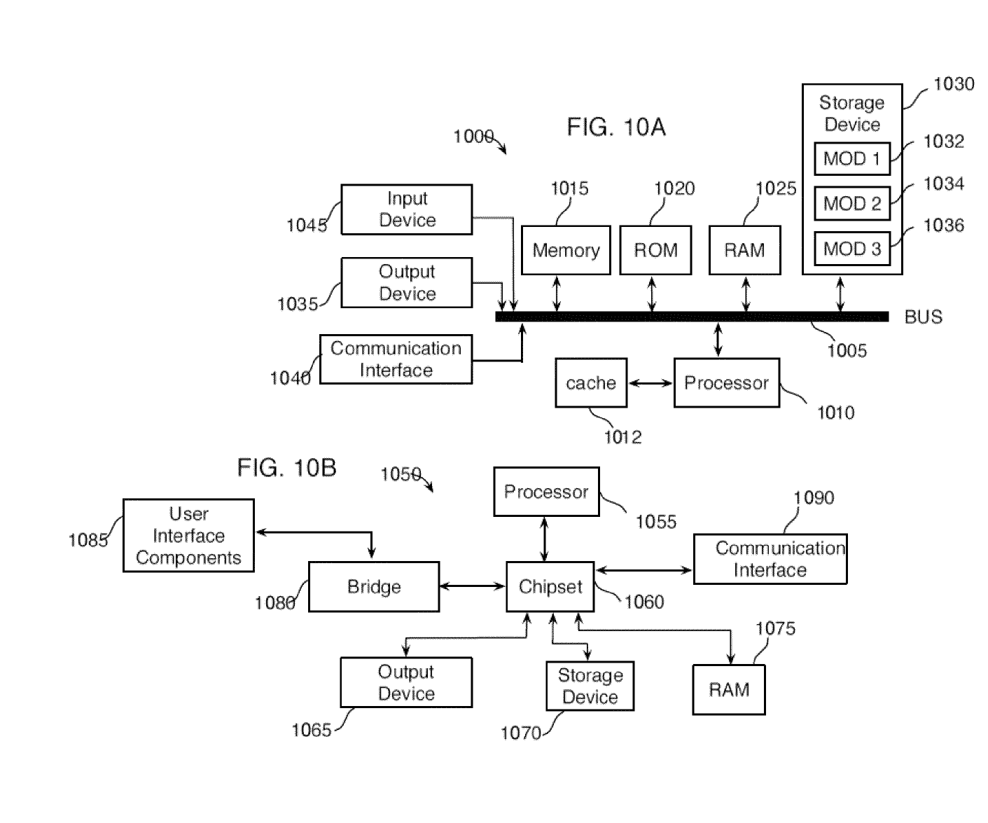

With reference now to FIG. 10A, and FIG. 10B, FIG. 10A, and FIG. 10B show exemplary possible system embodiments. The more appropriate embodiment will be apparent to those of ordinary skill in the art when practicing the present technology. Persons of ordinary skill in the art will also readily appreciate that other system embodiments are possible.

FIG. 10A illustrates a conventional system bus computing system architecture 1000 wherein the components of the system are in electrical communication with each other using a bus 1005. Exemplary system 1000 includes a processing unit (CPU or processor) 1010 and a system bus 1005 that couples various system components including the system memory 1015, such as read only memory (ROM) 1020 and random access memory (RAM) 1025, to the processor 1010. The system 1000 can include a cache of high-speed memory connected directly with, in close proximity to, or integrated as part of the processor 1010. The system 1000 can copy data from the memory 1015 and/or the storage device 1030 to the cache 1012 for quick access by the processor 1010. In this way, the cache can provide a performance boost that avoids processor 1010 delays while waiting for data. These and other modules can control or be configured to control the processor 1010 to perform various actions. Other system memory 1015 may be available for use as well. The memory 1015 can include multiple different types of memory with different performance characteristics. The processor 1010 can include any general purpose processor and a hardware module or software module, such as module 1 1032, module 2 1034, and module 3 1036 stored in storage device 1030, configured to control the processor 1010 as well as a special-purpose processor where software instructions are incorporated into the actual processor design. The processor 1010 may essentially be a completely self-contained computing system, containing multiple cores or processors, a bus, memory controller, cache, etc. A multi-core processor may be symmetric or asymmetric.

To enable user interaction with the computing device 1000, an input device 1045 can represent any number of input mechanisms, such as a microphone for speech, a touch-sensitive screen for gesture or graphical input, keyboard, mouse, motion input, speech and so forth. An output device 1035 can also be one or more of a number of output mechanisms known to those of skill in the art. In some instances, multimodal systems can enable a user to provide multiple types of input to communicate with the computing device 1000. The communications interface 1040 can generally govern and manage the user input and system output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read only memory (ROM) 1020, and hybrids thereof.

The storage device 1030 can include software modules 1032, 1034, 1036 for controlling the processor 1010. Other hardware or software modules are contemplated. The storage device 1030 can be connected to the system bus 1005. In one aspect, a hardware module that performs a particular function can include the software component stored in a computer-readable medium in connection with the necessary hardware components, such as the processor 1010, bus 1005, display 1035, and so forth, to carry out the function.

FIG. 10B illustrates a computer system 1050 having a chipset architecture that can be used in executing the described method and generating and displaying a graphical user interface (GUI). Computer system 1050 is an example of computer hardware, software, and firmware that can be used to implement the disclosed technology. System 1050 can include a processor 1055, representative of any number of physically and/or logically distinct resources capable of executing software, firmware, and hardware configured to perform identified computations. Processor 1055 can communicate with a chipset 1060 that can control input to and output from processor 1055. In this example, chipset 1060 outputs information to output 1065, such as a display, and can read and write information to storage device 1070, which can include magnetic media, and solid state media, for example. Chipset 1060 can also read data from and write data to RAM 1075. A bridge 1080 for interfacing with a variety of user interface components 1085 can be provided for interfacing with chipset 1060. Such user interface components 1085 can include a keyboard, a microphone, touch detection and processing circuitry, a pointing device, such as a mouse, and so on. In general, inputs to system 1050 can come from any of a variety of sources, machine generated and/or human generated.

Chipset 1060 can also interface with one or more communication interfaces 1090 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 1055 analyzing data stored in storage 1070 or 1075. Further, the machine can receive inputs from a user via user interface components 1085 and execute appropriate functions, such as browsing functions by interpreting these inputs using processor 1055.

It can be appreciated that exemplary systems 1000 and 1050 can have more than one processor 1010 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method for managing application data using an online content management system, the method comprising:
communicating with a first version of an application installed on a first computing device, the first version of the application being associated with a user account;
receiving, from the first version of the application installed on the first computing device, data about a state of the first version of the application associated with the user account;
communicating with at least a second version of the application installed on at least a second computing device, the at least the second version of the application also being associated with the user account; and
transmitting, to at least the second version of the application installed on at least the second computing device, the data about the state of the first version, wherein the data about the state of the first version is capable of being utilized, at least in part, to configure the second version to have a state synced with the first version, and wherein the first computing device and the second computing device are running different operating systems.

2. The computer-implemented method of claim 1, further comprising:
receiving data about a state of the second version installed on the second computing device;
analyzing the data about the state of the second version and the data about the state of the first version; and
detecting a conflict event based on the analyzing, wherein configuring the second version comprises resolving the conflict event using at least in part a conflict event resolution algorithm.

3. The computer-implemented method of claim 2, wherein the conflict event comprises at least one of a plurality of conflicting scheduled events, a plurality of conflicting contact information entries, a plurality of conflicting content item versions, or a plurality of conflicting content item names.

4. The computer-implemented method of claim 2, wherein the conflict resolution algorithm comprises at least one of choosing a most recent state, choosing a state associated with a higher prioritized computing device, or merging at least some portions of the states.

5. The computer-implemented method of claim 1, further comprising:
determining that the application and the user account has enabled application data syncing prior to the configuring of the second version.

6. The computer-implemented method of claim 1, wherein the user account is further associated with an online content management system.

7. The computer-implemented method of claim 1, further comprising:
storing one or more files with the user account in conjunction with the state of the first version;
receiving an authorization for at least one of the first version of the application or the second version of the application to access the one or more files; and
providing the at least one of the first version of the application or the second version of the application with access to the one or more files based on the receiving of the authorization.

8. A system comprising:
a processor;
a computer readable medium; and
computer readable instructions, stored on the computer readable medium, that when executed by the processor are effective to cause the system to:
store application data associated with an account;
determine that the application data has been modified on a first computing device associated with the account;
configure the modified application data to be compatible with at least a second computing device associated with the account, the second computing device corresponding to a platform different from the first computing device; and
transmit the modified application data to at least the second computing device associated with the account.

9. The system of claim 8, wherein the account is at least one of a user account associated with an online content management system or an application account associated with the online content management system.

10. The system of claim 9, wherein the user account associated with the online content management system includes a plurality of data partitions, each data partition being configured to store application data for one of a plurality of applications.

11. The system of claim 9, wherein the application account associated with the online content management system includes a plurality of data partitions, each data partition being configured to store application data for one of a plurality of user accounts.

12. The system of claim 9, wherein the determining that the application data has been modified on the first computing device comprises receiving a notification indicating that the application data has been modified on the first computing device.

13. The system of claim 12, wherein the notification is associated with at least one of a push notification, a fetch notification, or a periodic poll.

14. The system of claim 8, wherein the computer readable instructions cause the system to further authenticate that application data syncing has been enabled prior to the transmitting of the modified application data to the at least the second computing device.

15. A non-transitory computer-readable medium storing computer executable instructions for causing a computer to perform a method comprising:
storing application data associated with an account;
determining that the application data has been modified on a first computing device associated with the account;
configuring the modified application data to be compatible with at least a second computing device associated with the account, the second computing device corresponding to a platform different from the first computing device; and
transmitting the modified application data to at least the second computing device associated with the account.

16. The non-transitory computer-readable medium of claim 15, wherein the method further comprises:
receiving application data that has been modified on the second computing device associated with the account;
analyzing the application data modified on the first computing device and the application data modified on the second computing device; and
detecting a conflict event based on the analyzing, wherein the configuring of the modified application data comprises resolving the conflict event using at least in part a conflict event resolution algorithm.

17. The non-transitory computer-readable medium of claim 16, wherein the conflict event comprises at least one of a plurality of conflicting scheduled events, a plurality of conflicting contact information entries, a plurality of conflicting content item versions, or a plurality of conflicting content item names.

18. The non-transitory computer-readable medium of claim 16, wherein the conflict resolution algorithm comprises at least one of choosing a most recent state, choosing a state associated with a higher prioritized computing device, or merging at least some portions of the states.

19. The non-transitory computer-readable medium of claim 15, wherein the account is at least one of a user account associated with an online content management system or an application account associated with the online content management system.

20. The non-transitory computer-readable medium of claim 15, wherein the determining that the application data has been modified on the first computing device comprises receiving a notification indicating that the application data has been modified on the first computing device, the notification being associated with at least one of a push notification, a fetch notification, or a periodic poll.
